(19) United States
(12) Patent Application Publication
(10) Pub. No.: US 2003/0211911 A1
(43) Pub. Date: Nov. 13, 2003

(54) Belt

(76) Inventor: Susan Welk, Lakewood, CO (US)

Correspondence Address: Jeffrey Thurnau, The Gates Corporation, Mail Stop 31-4-1-A3, 900 S. Broadway, Denver, CO, 80209, US

(21) Appl. No.: 10/143,060

(22) Filed: May 10, 2002

(51) Int. Cl. F16G 1/00; F16G 5/00; F16G 9/00

(52) U.S. Cl. 474/260; 474/263

(57) ABSTRACT

A multi-ribbed belt having an elastomeric body and tensile cord embedded therein. The tensile cord comprises polyamide or polyester twisted strands. The elastic modulus of the belt is in the range of greater than 2000 N/mm to approximately 5000 N/mm.

### FIELD OF THE INVENTION

The invention relates to a belt and more particularly to a multi-ribbed power transmission belt.

### BACKGROUND OF THE INVENTION

Power transmission belts are widely used to transmit rotary power. A belt is generally installed between a driver and driven pulley, such as in the case of an accessory belt drive on a vehicle engine.

The belt comprises a tensile cord embedded in an elastomeric material. The tensile cord, or cords, are oriented parallel to a longitudinal axis. The tensile cord may be wound on a belt build in a continuous manner during fabrication.

Power transmission belts must possess sufficient tensile strength to allow a required torque, and load, to be transmitted between pulleys.

A belt having a high tensile strength also will generally have a commensurately high modulus. A belt having a high modulus will be relatively stiff. Further, installation of a prior art high modulus belt requires adjustable pulleys.

A low modulus belt may be used in situations where the torque to be transmitted is less than that required for a high load application. Low modulus belts are fabricated using tensile cords with a predetermined preload, or little or no preload. They may be fabricated using tensile cords having a twist as well. Polyamide 4.6 is known for use in tensile cords.

Representative of the art is EP 0 625 650 to Gates that discloses a low modulus belt having a tensile cord wound with a preload in a longitudinal direction with a modulus in the range of 1500 to 3000 N/mm.

Also representative of the art is U.S. Pat. No. 6,033,331 to Winninger et al. (2000) which discloses a belt having a supporting structure such that the belt exhibits an average stress-elongation slope ranging from 12 to 20 daN/% of elongation per width centimeter wherein a distance between twisted strands being in the range of 0 to 4 d.

What is needed is a multi-ribbed belt having a modulus in the range of greater than 2000 N/mm to approximately 5000 N/mm. The present invention meets these needs.

### SUMMARY OF THE INVENTION

The primary aspect of the invention is to provide a multi-ribbed belt having a modulus in the range of greater than 2000 N/mm to approximately 5000 N/mm.

Other aspects of the invention will be pointed out or made obvious by the following description of the invention and the accompanying drawings.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a cross-sectional view of the inventive belt.

FIG. 2 is a side view of tensile member twisted strands.

FIG. 3 is a table describing exemplary belt constructions.

### DETAILED DESCRIPTION OF THE INVENTION

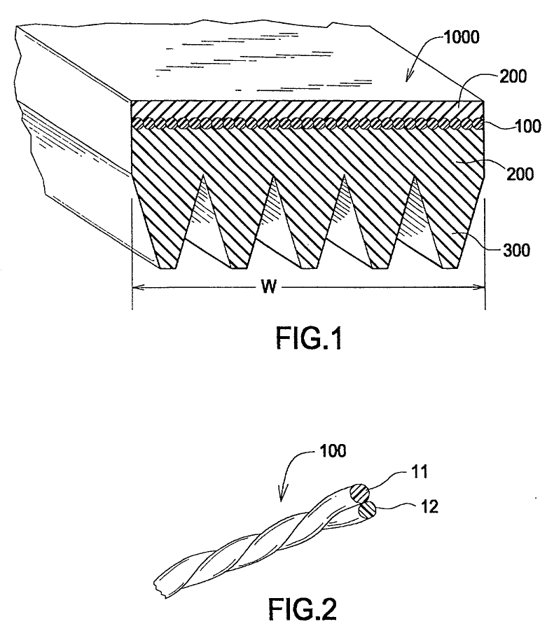

FIG. 1 is a cross-sectional view of the inventive belt. The elastic modulus range of the inventive belt allows ease of installation by eliminating the need for adjustment of driven pulley centers while allowing the belt to endure high dynamic stresses and to transmit large forces with reduced slippage, such as in an automotive application.

Belt 1000 comprises tensile members 100, which are shown embedded in elastomeric body 200. Tensile members 100 extend in a longitudinal direction along an endless length of the belt.

A belt profile comprises ribs 300 that project from one side of the belt, and extend longitudinally along an endless length of the belt as well. Ribs 300 engage a pulley, for example in an engine accessory drive system (not shown). Although the belt described herein comprises a multi-ribbed profile, it may comprise any other profile as may be determined by an operating requirement, including a flat profile and a single rib v-belt profile.

Tensile members 100 comprise strands of polyamide 4.6. Members 100 may also comprise, polyamide 6, polyamide 6.6, polyester, and all equivalents. Tensile members 100 may comprise either a single strand or may comprise a twisted yarn comprising two or more strands twisted together. Tensile members 100 may also comprise a polyamide strand combined with a polyester strand as well. Tensile members 100 may also comprise fabric woven of the foregoing materials.

Elastomeric body 200 may comprise natural and synthetic rubbers, including but not limited to polychloroprene, alkylated chlorosulphonated rubber, polybutadiene, hydrogenated nitrile butadiene rubber (HNBR), or EPDM, as well as the equivalents and combinations of any of the foregoing.

FIG. 2 is a side view of tensile member twisted strands. Tensile member 100 comprises strands 11 and 12 which are twisted together. Strands 11 and 12 may have either an “S” or “Z” twist. Tensile member 100 may also comprise more than two twisted strands, for example, three or more.

The belt constructions disclosed herein produce belt elastic modulii in a range from 2000 N/mm up to approximately 5000 N/mm. It is assumed that the tensile members are the major contributor to the belt elastic modulus, namely, the elastic modulus of the belt is substantially equal to the elastic modulus of the tensile members.

A belt having an elastic modulus in the disclosed range is achieved by a combination of materials and construction techniques. The materials and construction techniques include selection of denier, tensile member twist multiplier, tensile member treatment tension, tensile member cord lay tension, tensile member cord pack, and belt elongation at cure. Each of these variables are combined in order to achieve a desired belt elastic modulus.

For example, to achieve a belt with a polyamide tensile member having an elastic modulus at an upper end of the range, an exemplary combination may comprise large size tensile member denier, low tensile member twist multiplier, high tensile member treatment tension, high tensile member cord lay tension, high tensile member cord pack and belt elongation during cure.

In another example, to achieve a belt with a polyester tensile member having an elastic modulus at a low end of the range an exemplary combination may comprise small size tensile member denier, high tensile member twist multiplier, low tensile member treatment tension, low tensile member cord lay tension, low tensile member cord pack and no elongation during cure.

Tensile member denier relates to tensile member weight per unit length measurement. Selecting a tensile member denier from approximately 5040 to 8400, without changing any of the other design variables, can allow a belt elastic modulus to be varied approximately 25%.

Tensile member twist multiplier relates to the ratio of turns per inch to the square root of the yarn count. Selecting a tensile member twist multiplier in a range of approximately 3 to 6, without changing any of the other design variables, can vary an elastic modulus approximately 30%.

Tensile member treatment tension relates to a tension applied to a tensile member yarn as it is fabricated. Changing a tensile member treatment tension in a range from approximately 18N to 85N, without changing any of the other design variables, can vary an elastic modulus approximately 30%.

Tensile member cord lay tension relates to a tension applied to the tensile member as it is applied to the belt build during construction. Selecting a tensile member cord lay tension from approximately 13N to 76N, without changing any of the other design variables, can allow an elastic modulus to be varied approximately 10%.

Elongation at cure relates to elongation of the belt during the cure process. Selecting an elongation in the range of approximately 0% to 2.5%, without changing any of the other design variables, can vary an elastic modulus approximately 50%.

Tensile member cord pack relates to the number of tensile members per unit width of belt. Selecting a tensile member cord pack in the range of approximately 50% to 90%, without changing any of the other design variables, can vary an elastic modulus approximately 15%.

As to tensile member cord pack, each tensile member 100 has a diameter. The tensile members are constructed in the inventive belt in a configuration having a high cord pack. For example, a 100% cord pack belt has a closely laid wind wherein the tensile members are immediately adjacent to each other across a belt width, see FIG. 1. Lower tensile member cord packs have increasingly more and more space between adjacent tensile members. For example, a tensile member having a diameter of 0.040″ would have a 100% cord pack at 25 cords per inch of belt width. A belt having 22.5 tensile members per inch of belt width (0.040″ diameter) would have a 90% cord pack. A belt having 20 tensile members per inch of belt width would have an 80% cord pack. Further, a tensile member having a diameter of 0.050″ would have a 100% cord pack with 20 tensile members per inch of belt width. Such a belt having 18 tensile members per inch of belt width would have a 90% cord pack, and so on.

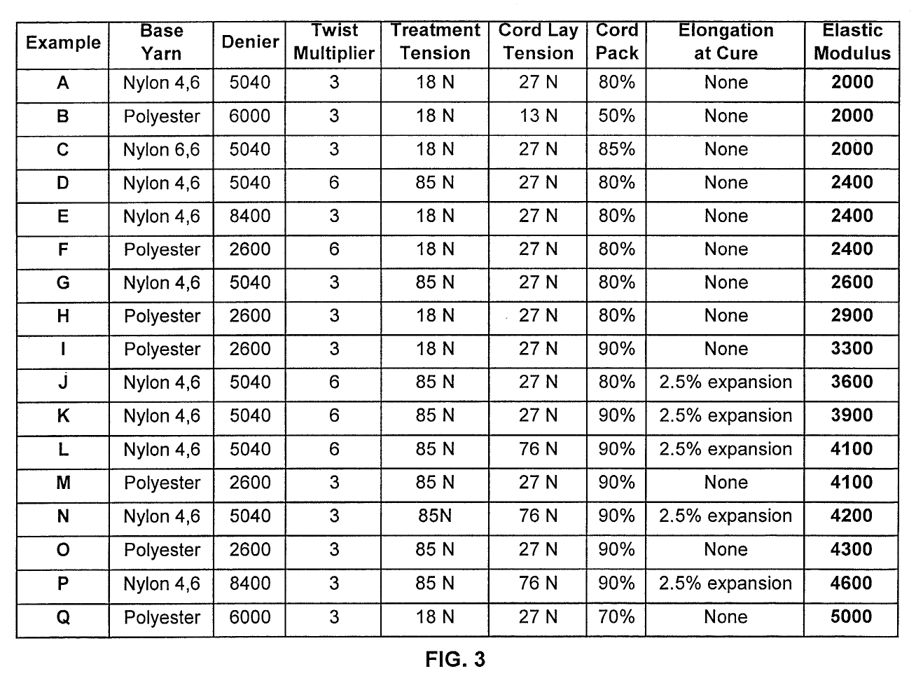

Exemplary belt constructions are described in FIG. 3. For example, construction example “D” uses a polyamide 4.6 5040-denier tensile member, a tensile member twist multiplier of 6, a tensile member treatment tension of approximately 85N, a tensile member cord lay tension of approximately 27N, a tensile member cord pack of approximately 80%, and no elongation at cure. This exemplary construction results in a belt having an elastic modulus of approximately 2400 N/mm.

Exemplary belt constructions A though Q described in FIG. 3 are not offered by way of limitation. Further, the values noted in FIG. 3 are exemplary and are not intended to limit a range of values which may be used to realize a particular belt elastic modulus. Any combination of the foregoing belt and tensile member variables may be used to achieve a desired belt elastic modulus in the disclosed range.

The range of inventive belt constructions gives an elastic modulus relative to a belt width W, see FIG. 1, in the range of greater than 2000 N/mm to approximately 5000 N/mm per belt strand. Said elastic modulus comprises a stress-strain curve average slope in a stress range of 10 N/rib/strand to 350 N/rib/strand on the third of three belt elongation cycles. This results in an elongation in the range of approximately 0.5% to 10% of a total belt length.

The belt test apparatus includes a tensile test machine, such as an Instron® or equivalent known in the art. To test, a belt is placed in an inverted position on a set of test pulleys in the tensile test machine. Inverted meaning the ribbed portion is not engaged with the test pulleys. The test pulleys are not rotated during the test. The belt is subjected to three load cycles on the test machine in order to stabilize the belt. The belt modulus is determined from the third of three load cycles on the test machine.

Although embodiments of the invention have been described herein, it will be obvious to those skilled in the art that variations may be made in the construction and relation of parts without departing from the spirit and scope of the invention described herein.

I claim:

1. A multi-ribbed belt comprising:
an elastomeric body;
a tensile member embedded in the elastomeric body;
the tensile member comprising twisted strands of polyamide 4.6;
the belt having a tensile member cord pack in the range of approximately 80% to 90%; and
the belt having a stress-elongation diagram which exhibits an average slope ranging from greater than 3000 N/mm to approximately 5000 N/mm.

2. The multi-ribbed belt as in claim 1, wherein the tensile member comprises a denier in the range of approximately 5040 to 8400.

3. The multi-ribbed belt as in claim 1, wherein the tensile member comprises a twist multiplier in the range of approximately 3 to 6.

4. The multi-ribbed belt as in claim 1, wherein the tensile member comprises a treatment tension in the range of approximately 18N to 85N.

5. The multi-ribbed belt as in claim 1, wherein the tensile member comprises a cord lay tension in the range of approximately 27N to 76N.

6. A belt comprising:
an elastomeric body;
a tensile member embedded in the elastomeric body,
the tensile member comprises twisted strands of polyester;
the belt having a tensile member cord pack in the range of approximately 50% to 90%; and
the belt having a stress-elongation diagram which exhibits an average slope ranging from greater than 2000 N/mm to approximately 5000 N/mm.

7. The belt as in claim 6, wherein the tensile member comprises a denier in the range of approximately 2600 to 6000.

8. The belt as in claim 6, wherein the tensile member comprises a twist multiplier in the range of approximately 3 to 6.

9. The belt as in claim 6, wherein the tensile member comprises a treatment tension in the range of approximately 18N to 85N.

10. The belt as in claim 6, wherein the tensile member comprises a cord lay tension in the range of approximately 13N to 27N.

11. A belt comprising:
an elastomeric body;
a tensile member embedded in the elastomeric body;
the tensile member comprising twisted strands;
the belt having a tensile member cord pack of approximately 85%; and
the belt having a stress-elongation diagram which exhibits an average slope ranging from greater than 3000 N/mm to approximately 5000 N/mm.

12. The belt as in claim 11, wherein the tensile member comprises a denier in the range of approximately 5040 to 8400.

13. The belt as in claim 11, wherein the tensile member comprises a twist multiplier in the range of approximately 3 to 6.

14. The belt as in claim 11, wherein the tensile member comprises a treatment tension in the range of approximately 18N to 85N.

15. The belt as in claim 11, wherein the tensile member comprises a cord lay tension in the range of approximately 27N to 76N.

16. The belt as in claim 11, wherein the belt comprises an elongation at cure in the range of approximately 0% to 2.5%.

17. The belt as in claim 11, wherein the tensile member is of a type selected from the group consisting of:
polyamide 6;
polyamide 6.6; and
a combination of the foregoing.
